(19) United States
(12) Patent Application Publication
(10) Pub. No.: US 2009/0047556 A1
(43) Pub. Date: Feb. 19, 2009

(54) FUEL CELL SYSTEM

(76) Inventors: Hidenori Suzuki, Yokohama-shi (JP); Kiyoshi Senoue, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/089,949

(22) PCT Filed: Oct. 12, 2006
(86) PCT No.: PCT/JP2006/320394

§ 371 Date: Apr. 11, 2008

(30) Foreign Application Priority Data
Oct. 14, 2005 (JP) 2005-300387

(51) Int. Cl. H01M 8/04

(52) U.S. Cl. 429/24; 429/22

(57) ABSTRACT

The electromotive force of each of power generating cells of a fuel cell unit is compared with a first threshold voltage E1 for the electromotive force of the power generating cells immediately after fuel injection or a second threshold voltage E2 for the electromotive force when the fuel is running out. Using the results of comparison, a decision is made as to whether or not the electromotive forces of all the power generating cells exceed the first threshold voltage E1 within a give time τ1 or whether or not the electromotive force of some of the power generating cells falls below the second threshold voltage E2. An annunciator indicates the results of decision.

### CROSS-REFERENCE TO RELATED APPLICATIONS

This is a Continuation application of PCT Application No. PCT/JP2006/320394, filed Oct. 12, 2006, which was published under PCT Article 21(2) in Japanese.

This application is based upon and claims the benefit of priority from prior Japanese Patent Application No. 2005-300387, filed Oct. 14, 2005, the entire contents of which are incorporated herein by reference.

### BACKGROUND OF THE INVENTION

1. Field of the Invention

The present invention relates to a fuel cell system used as the power source of portable electronic equipment and the like.

2. Description of the Related Art

The miniaturization of portable electronic equipment, such as portable audio equipment, PDAs (Personal Digital Assistants), etc., is striking. With the miniaturization of portable electronic equipment, attempts have been made to use a fuel cell as the power source. The fuel cell is capable of generating electricity by only supplying fuel and an oxidizer. Furthermore, the fuel cell, having an advantage of being capable of continuously generating electricity by supplying or exchanging the fuel alone, is relatively easy to miniaturize and therefore useful as the power source of portable electronic equipment.

In recent years, attention has been paid to a direct methanol fuel cell (hereinafter referred to as DMFC) as a fuel cell. With the DMFC, an electrolytic film is set between anode and cathode poles. Each of the anode and cathode poles includes a current collecting body and a catalyst layer. The anode pole is supplied with a water solution of a methanol as fuel and protons are generated in the catalyst layer through a catalytic reaction. The cathode pole (air pole) has an air inlet and is supplied with air through this air inlet. Oxygen contained in the supplied air and protons generated in the anode pole and passed through the catalyst layer cause a catalytic reaction in the catalyst layer of the cathode pole, thereby generating electricity.

Thus, the DMFC uses methanol, which is high in energy density, as the fuel, can directly take current out of methanol in the catalyst layer of the cathode pole, and moreover does not require reforming of the fuel. The DMFC is therefore easy to miniaturize. In addition, the fuel is easy to handle as compared with a hydrogen gas; therefore, the DMFC is showing promise as the power source of portable electronic equipment.

### BRIEF SUMMARY OF THE INVENTION

By the way, a DMFC as a single unit is low in electromotive force. In using such a DMFC as the power source of electronic equipment, therefore, a plurality of unit DMFCs, called power generating cells, is usually used to form a unit and these power generating cells are connected in series to construct a DMFC unit, thereby obtaining a desired output voltage.

With the DMFC unit thus constructed, however, when even one of the power generating cells runs out of fuel, the output voltage of the entire DMFC unit drops, causing a problem of unstable operation of portable electronic equipment. In addition, when there is a power generating cell that cannot output desired electromotive force because of damage or the like even if the supply of fuel to each power generating cell is normal, the DMFC unit as a whole fails to obtain a desired output voltage, causing a problem of unstable operation of portable electronic equipment.

The object of the present invention is to provide a fuel cell system which can exactly indicate the conditions of the DMFC unit to the outside.

According to an aspect of the invention, there is provided a fuel cell system comprising: a fuel cell unit including a plurality of power generating cells; threshold setting means for setting a first threshold and a second threshold for each of the power generating cells; comparison means for comparing the electromotive force of each of the power generating cells with either of the first threshold or the second threshold; first time setting means for setting a first standby time with termination of fuel injection into the fuel cell unit as starting point of time; decision means for making a decision of, (a) when the comparison means makes comparisons using the first threshold, whether or not the electromotive forces of all the power generating cells exceed the first threshold within the first standby time and, (b) when the comparison means makes comparisons using the second threshold, whether or not the electromotive force of at least one of the power generating cells falls below the second threshold; control means for controlling a supply of power to a load by the fuel cell unit based on results of decision by the decision means; and annunciation means for indicating the results of decision by the decision means.

### BRIEF DESCRIPTION OF THE SEVERAL VIEWS OF THE DRAWING

FIG. 1 is a block diagram showing the configuration of a fuel cell system according to an embodiment of the present invention;

FIG. 2 is a block diagram showing the circuit arrangement of the fuel cell system shown in FIG. 1;

FIG. 3 is a timing chart showing signal waveforms for use in explanation of the operation of the circuits of the fuel cell system shown in FIG. 1; and

FIG. 4 is a flowchart for use in explanation of the operation of the fuel cell system shown in FIG. 1 according to another embodiment of the present invention.

### DETAILED DESCRIPTION OF THE INVENTION

A fuel cell system according to an embodiment of the present invention will be described hereinafter with reference to the accompanying drawings.

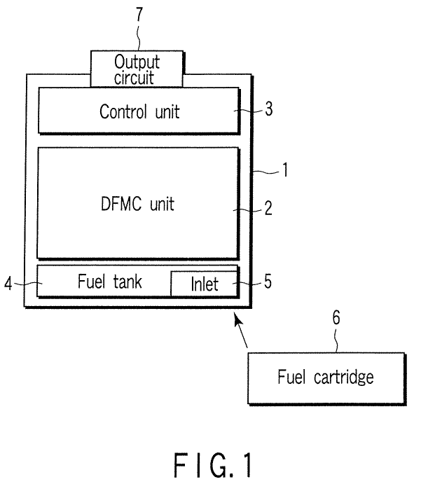

FIG. 1 shows the fuel cell system according to the embodiment of the present invention. The fuel cell system shown in FIG. 1 has a case 1, a DMFC unit (Direct Methanol Fuel Cell unit) 2, a control unit 3, a fuel tank 4, and an output circuit 7.

The case 1 houses the fuel cell system. The DMFC unit 2 includes a plurality of power generating cells 2a to 2c to be described later. Each of the power generating cells 2a to 2c has an electrolytic film set between its anode and cathode poles. Each of the anode and cathode poles includes a current collecting body and a catalyst layer. The anode pole is supplied with a water solution of a methanol as fuel and protons are generated in the catalyst layer through a catalytic reaction. On the other hand, the cathode pole (air pole) has an air inlet and is supplied with air through this air inlet. Oxygen contained in the supplied air and protons generated in the anode pole and passed through the electrolytic film cause a catalytic reaction in the catalyst layer to thereby generate electricity. The DMFC unit 2 of this embodiment is of a passive type, which enables supply either of fuel and air through convection or concentration gradient.

The fuel tank 4 holds pure methanol or a water solution of a methanol. Also, the fuel tank 4 has an inlet 5 into which a fuel cartridge 6 is removably inserted. When the fuel cartridge 6 is inserted, the fuel is injected through the inlet 5 into the fuel tank 4. The fuel is supplied through a supply path not shown to the DMFC unit 2.

The fuel that the fuel tank 4 holds is not limited to a methanol fuel. For example, the fuel may be ethanol fuel, such as a water solution of an ethanol or pure ethanol, dimethyl ether, formic acid, or any other liquid fuel. In any case, the tank holds a liquid fuel which meets the fuel cell.

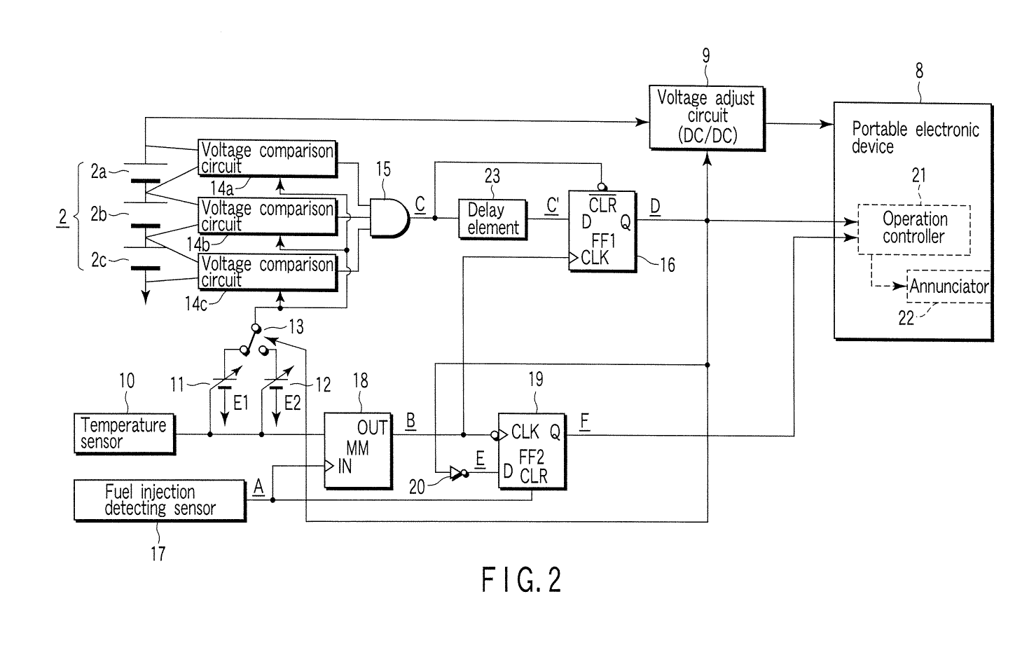

The control unit 3 controls the supply of a supply voltage to portable electronic equipment as a load shown in FIG. 2 and is constructed as control means from logic circuits to be described later.

In this embodiment, the DMFC unit 2 has a plurality of power generating cells 2a to 2c and generates a desired output voltage by connecting the power generating cells 2a to 2c in series. To the DMFC unit 2 is connected a voltage adjust circuit 9, which has, for example, a DC-DC converter and adjusts the output voltage of the DMFC unit 2 for application to the portable electronic equipment 8.

Voltage comparison circuits 14a to 14c as comparison means are connected to the power generating cells 2a to 2c, respectively, of the DMFC unit 2. The voltage comparison circuits 14a to 14c are connected through a switch 13 as switching means to either a first threshold voltage generating unit 11 or a second threshold voltage generating unit 12 as threshold setting means. The first threshold voltage generating unit 11 generates a first threshold voltage E1, while the second threshold voltage generating unit 12 generates a second threshold voltage E2. The first threshold voltage E1 is determined based on the electromotive force of each of the power generating cells 2a to 2c immediately after fuel injection. The second threshold voltage is determined based on the electromotive force of each of the power generating cells 2a to 2c when it runs out of fuel. In this embodiment, a temperature sensor 10 as temperature detecting means is connected to the first and second threshold voltage generating units 11 and 12. The temperature sensor 10 detects the temperature of the vicinity of the DMFC unit 2 and corrects the first and second threshold voltages E1 and E2 based on the detected output. It is known that the electromotive force of each of the power generating cells 2a to 2c immediately after it has been fueled and when it is running out of fuel tends to change with ambient temperatures. As stated above, the first and second threshold voltages E1 and E2 are corrected according to ambient temperatures.

Each of the voltage comparison circuits 14a to 14c compares the electromotive force of a corresponding one of the power generating cells 2a to 2c with the first threshold voltage E1 or the second threshold voltage E2 and generates an output at an H (high) level when the electromotive force exceeds a threshold voltage to be compared with (either the first threshold voltage E1 or the second threshold voltage E2).

To the voltage comparison circuits 14a to 14c is connected an AND gate 15, which outputs an H-level only when input signals (the outputs of the voltage comparison circuits 14a to 14c) are all at the H-level and outputs an L (low) level otherwise. To the AND gate 15 are connected the input terminal of a delay element 23 as delay means and the CLR (negation) terminal of a first D-type flip-flop 16. To the output terminal of the delay element 23 is connected the D terminal of the first D-type flip-flop 16. The delay element 23 sets a waiting time from when the electromotive forces of all the power generating cells 2a to 2c exceed the first threshold voltage E1 until the supply of power to the portable electronic equipment is started. The delay element 23 delays the output of the AND gate 15 by a given set time τ2 and applies it to the D terminal of the first D-type flip-flop 16. In this embodiment, the set time τ2 of the delay element 23 is set to the order of tens of seconds. On the other hand, a fuel injection detecting sensor 17 monitors the injection of fuel from the fuel cartridge 6 into the fuel tank 4 and generates an H-level output upon detecting the termination of fuel injection. To the fuel injection detecting sensor 17 are connected the IN terminal of a monostable multivibrator (MM) 18 as time setting means, and the CLR terminal of a second D-type flip-flop 19. When receiving an H-level output of the fuel injection detecting sensor 17 at the IN terminal, the monostable multivibrator 18 performs an operation corresponding to one period. The operating time for one period of the monostable multivibrator 18 is set to a time τ1 which elapses from when the injection of fuel into the fuel tank 4 is terminated until the fuel is distributed to each of the power generating cells 2a to 2c, during which time an H-level signal is output from the OUT terminal. The monostable multivibrator 18, which is connected to the temperature sensor 10, corrects the set time τ1 based on the detected output from the temperature sensor 10, i.e., the ambient temperature of the DMFC unit 2. To the OUT terminal of the monostable multivibrator 18 are connected the CLK terminal of the first D-type flip-flop 16 and the CLK (negation) of the second D-type flip-flop 19.

The first D-type flip-flop 16 outputs from the Q terminal the state of the D terminal at the time the H-level output of the monostable multivibrator 18 is input to the CLK terminal. Also, the first D-type flip-flop 16 is cleared when the output of the AND gate 15 is at the L-level. The Q terminal of the first D-type flip-flop 16 is connected to the D terminal of the second D-type flip-flop 19 through an inverter 20, to the voltage adjust circuit 9, to the switch 13, and to an operation controller 21 in the portable electronic equipment 8. When the Q-terminal output of the first D-type flip-flop 16 is at the H-level, a feed enable signal D goes high, which is applied to the voltage adjust circuit 9, the switch 13, and the operation controller 21. Upon receipt of the H-level feed enable signal D, the voltage adjust circuit 9 starts voltage adjustment. The switch 13 normally connects the voltage comparison circuits 14a to 14c to the first threshold voltage generating unit 11 (FIG. 2 shows this state). Upon receipt of the H-level feed enable signal D, the switch connects the voltage comparison circuits 14a to 14c to the second threshold voltage generating unit 12. To the operation controller 21 is connected an annunciator 22 as annunciation means, which uses, for example, a lamp and a buzzer in combination.

Upon receipt of the feed enable signal D at H-level, the operation controller 21 decides that the supply of power from the DMFC unit 2 is normal and notifies the user to that effect via the annunciator 22. In this case, for example, the annunciator 22 turns on a lamp to notify the user that the supply of power is normal. When the supply of the H-level feed enable signal D is stopped, the operation controller 21 decides that the power generating cells 2a to 2c have run out of fuel and notifies the user to that effect via the annunciator 22. In this case, the annunciator 22, for example, blinks the lamp on and off to notify the user to the effect that the fuel is running out.

The second D-type flip-flop 19 outputs from the Q terminal the state of the D terminal at the time the L-level output of the monostable multivibrator 18 is input to the CLK (negation) terminal. The second D-type flip-flop 19 is cleared when the output of the fuel injection detecting sensor 17 is at the H-level. The Q terminal of the second D-type flip-flop 19 is connected to the operation controller 21. When the output at the Q terminal of the second D-type flip-flop 19 is at the H-level, an abnormal fuel supply signal F goes high and is applied to the operation controller 21. Based on the H-level abnormal fuel supply signal F, the operation controller 22 decides that the supply of power from the DMFC unit 2 is abnormal and makes a notification to that effect via the annunciator 22. In this notification, for example, the annunciator 22 blinks the lamp on and off and at the same time sounds the buzzer to notify the user of abnormal fuel supply.

The operation of the fuel cell system of this embodiment will be described hereinafter.

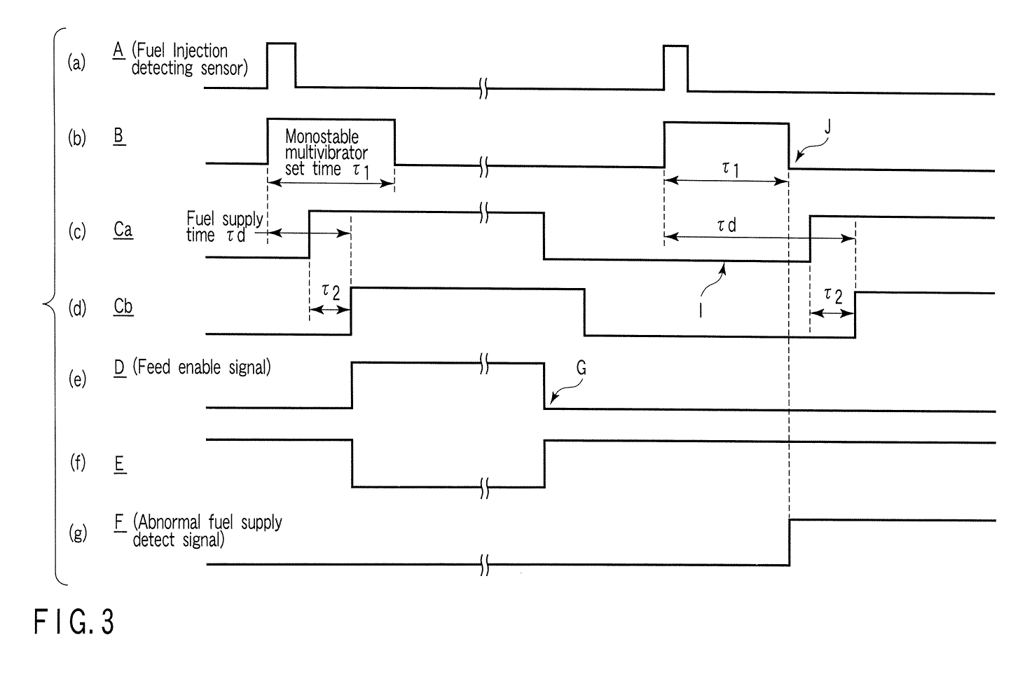

When fuel is injected from the fuel cartridge 6 into the fuel tank 4 through the inlet 5 as described above, the fuel injection is monitored by the fuel injection detecting sensor 17. When the fuel injection is terminated, the fuel injection detecting sensor 17 generates an output A at H-level as shown in FIG. 3(a). The output A is applied to the monostable multivibrator 18. When the output A is at the H-level, the monostable multivibrator 18 generates an output B which is at the H-level only for the set time of τ1 as shown in FIG. 3(b). The output B is applied to the CLK terminal of the first D-type flip-flop 16.

In this state, the electromotive force of each of the power generating cells 2a to 2c is applied to a corresponding one of the voltage comparison circuits 14a to 14c. The voltage comparison circuits 14a to 14c are supplied through the switch 13 with the first threshold voltage E1 from the first threshold voltage generating unit 11. The voltage comparison circuits 14a to 14c compare the electromotive forces of the power generating cells 2a to 2c with the first threshold voltage E1 and generate H-level outputs when the electromotive forces of the power generating cells 2a to 2c exceed the first threshold voltage E1. When the outputs of the voltage comparison circuits 14a to 14c are all at the H-level, the AND gate 15 generates an output Ca at H-level as shown in FIG. 3(c). The output Ca is applied to the delay element 23 and delayed by the set time τ2, so that such an output Cb as shown in FIG. 3(d) is applied to the D terminal of the first D-type flip-flop 16. The first D-type flip-flop 16 has been cleared in advance by the L-level output Ca of the AND gate 15. If the output B of the monostable multivibrator 18 is at H-level at the time when the H-level output Ca of the AND gate 15 is applied through the delay element 23 to the D terminal, the state of the D terminal is output from the Q terminal. Accordingly, if the time (fuel supply time τd) from when the output A of the fuel injection detecting sensor 17 goes to the H-level until the H-level output Cb is input from the delay element 23 to the D terminal of the first D-type flip-flop 16 is within the set time τ1, the output D of the Q terminal as the feed enable signal goes to the H-level and is applied to the voltage adjust circuit 9, the switch 13, and the operation controller 21 because the first D-type flip-flop 16 is supplied at its D terminal with the H-level output Cb.

The operation controller 21 decides that the supply of power from the DMFC unit 2 is normal when the feed enable signal D is at the H-level and causes the annunciator 22 to make notification to that effect. In this case, the annunciator 22 turns on the lamp to notify the user that the supply of power is normal. In addition, the voltage adjust circuit 9 operates the DC-DC converter, then adjusts the output voltage of the DMFC unit 2 and applies it to the portable electronic equipment 8 when the feed enable signal D is at the H-level. Furthermore, the switch 13 is activated to connect the voltage comparison circuits 14a to 14c to the second threshold voltage generating unit 12 when the feed enable signal D goes to the H-level.

In this state, the electromotive force of each of the power generating cells 2a to 2c is applied again to a corresponding one of the voltage comparison circuits 14a to 14c. The voltage comparison circuits 14a to 14c are supplied through the switch 13 with the second threshold voltage E2 from the second threshold voltage generating unit 12 to compare the electromotive forces of the power generating cells 2a to 2c with the second threshold voltage E2. While the power generating cells 2a to 2c each generate a normal electromotive force that exceeds the second threshold voltage E2, both the output Ca of the AND gate 15 and the output D at the Q terminal of the first D-type flip-flop 16 remain at the H-level with the result that the feed enable signal D is maintained at the H-level.

After that, when the fuel of the power generating cells 2a to 2c becomes exhausted and the electromotive force of at least one of the power generating cells 2a to 2c falls below the second threshold voltage E2, the output Ca of the AND gate 15 goes to the L-level. This signal is input to the CLR terminal of the first D-type flip-flop 16 with the result that it is cleared and the output D at the Q terminal, that is, the feed enable signal D, goes to the L-level (refer to G in FIG. 3). When the feed enable signal D goes to the L-level, the operation controller 21 decides that the fuel of the power generating cells 2a to 2c is running out and causes the annunciator 22 to make notification to that effect. In this case, the annunciator 22 blinks the lamp on and off to notify the user to the effect that the fuel of the power generating cells 2a to 2c is running out, thereby prompting him or her to supply more fuel. In response to the feed enable signal D going to the L-level, the voltage adjust circuit 9 stops the operation of the DC-DC converter and the supply of the output voltage of the DMFC unit 2 to the portable electronic equipment 8. Furthermore, when the feed enable signal D goes to the L-level, the switch 13 is activated to connect the voltage comparison circuits 14a to 14c to the first threshold voltage generating unit 11. In this case, the output D of the first D-type flip-flop 16 is applied through the inverter 20 to the D terminal of the second D-type flip-flop 19 as an H-level output E shown in FIG. 3(f).

When fuel is injected again from the fuel cartridge 6 into the fuel tank 4, the fuel injection detecting sensor 17 generates such an H-level output A as shown in FIG. 3(a) at the termination of the fuel injection. The H-level output A is applied to the monostable multivibrator 18, which in turn generates an output B which is at the H-level for the set time τ1 as shown in FIG. 3(b).

In this state, the electromotive force of each of the power generating cells 2a to 2c is compared with the first threshold voltage E1 in a corresponding one of the voltage comparison circuits 14a to 14c.

For example, when the electromotive force of at least one of the power generating cells 2a to 2c falls below the first threshold voltage E1 due to damage or the like, the output Ca of the AND gate 15 is kept at the L-level (refer to I in FIG. 3). When, in this state, the set time τ1 elapses and the output B of the monostable multivibrator 18 goes to the L-level (refer to J in FIG. 3), that is, when the time (the fuel supply time τd) from when the output A of the fuel injection detecting sensor 17 goes to the H-level until the H-level output Ca of the AND gate 15 is input to the D terminal of the first D-type flip-flop 16 through the delay element 23 exceeds the set time τ1, the output D of the first D-type flip-flop 16 as the feed enable signal D goes to the L-level. At this point, the L-level output B of the monostable multivibrator 18 is applied to the CLK (negation) terminal of the second D-type flip-flop 19. When receiving the L-level output B of the monostable multivibrator 18 at its CLK (negation) terminal, the second D-type flip-flop 19, which has been cleared in advance by the H-level output A of the fuel injection detecting sensor 17, outputs the state of the D terminal at that time from the Q terminal. In this case, the H-level output E is being applied to the D terminal of the second D-type flip-flop 19 and hence the output F at the Q terminal goes to the H-level, outputting such an abnormal fuel supply signal F as shown in FIG. 3(g). This abnormal fuel supply signal F is applied to the operation controller 21.

When the abnormal fuel supply signal F is at the H-level, the operation controller 21 decides that the fuel supply to some of the power generating cells 2a to 2c is abnormal and causes the annunciator 22 to notify the user to that effect. In this case, the annunciator 22 blinks the lamp on and off and sounds the buzzer to notify the user to the effect that the fuel supply is abnormal.

The voltage adjust circuit 9 may be configured to, when the H-level abnormal fuel supply signal F is input, forcefully stop the operation of the DC-DC converter, thereby stopping application of the output voltage of the DMFC unit 2 to the portable electronic equipment 8.

As described above, this embodiment sets the feed enable signal D to the H-level when the electromotive forces of all of the power generating cells 2a to 2c exceed the first threshold voltage E1 within a preset time (τ1-τ2) from when the fuel injection detecting sensor 17 detected the termination of fuel injection. This H-level feed enable signal D causes the voltage adjust circuit 9 to adjust the output voltage of the DMFC unit 2 so that it can be applied to the portable electronic equipment 8 and causes the operation controller 21 to turn on the lamp in the annunciator 22 so as to make notification that the supply of power is normal. Accordingly, the user can confirm this indication to use the portable electronic equipment 8 which operates with stability owing to the normal supply of power. In addition, τ2 is set by the delay element 23 as the waiting time which elapses from the time when the electromotive forces of all of the power generating cells 2a to 2c exceed the first threshold voltage E1 to the time when the feed enable signal D goes to the H-level to start supply of power to the portable electronic equipment 8. Thereby, the supply of power to the portable electronic equipment 8 can be started in the state in which the electromotive force of each of the power generating cells 2a to 2c is stable, ensuring the stable operation of the portable electronic equipment 8.

When the power generating cells 2a to 2c run out of fuel and the electromotive force of at least one of them falls below the second threshold voltage E2, the feed enable signal D goes to the L-level. The L-level feed enable signal D stops the operation of the voltage adjust circuit 9 and causes the operation controller 21 to blink the lamp of the annunciator 22 on and off to prompt the user to supply more fuel. Therefore, the user can quickly know that the DMFC unit 2 is running out of fuel. The normal state can therefore be restored quickly by fueling the DMFC 2. In addition, stopping the operation of the voltage adjust circuit 9 makes it possible to prevent the continuation of power supply to the portable electronic equipment 8 in the state in which the fuel remains exhausted. Thereby, the portable electronic equipment 8 can be prevented from becoming unstable in operation and the power generating cells 2a to 2c can be prevented from being damaged due to fuel exhaustion.

When the electromotive forces of all of the power generating cells 2a to 2c cannot exceed the first threshold voltage E1 within the preset time τ1 from when the termination of fuel injection is detected by the fuel injection detecting sensor 17, the abnormal fuel supply signal F goes to the H-level. Upon receipt of the H-level abnormal fuel supply signal F, the operation controller 21 blinks the lamp in the annunciator 22 on and off and sounds the buzzer to notify the user to the effect that the fuel supply is abnormal. Accordingly, the user can promptly know that the fuel supply is abnormal and take measures, such as inspection of the DMFC unit 2 or overall exchange of the fuel cell system. In this case as well, the operation of the voltage adjust circuit 9 could be stopped to prevent the abnormality from spreading to the other (normal) power generating cells.

According to the embodiment of the present invention, as described above, the conditions of the DMFC unit 2, such as the condition of the output voltage of each of the power generating cells 2a to 2c, fuel exhaustion, or abnormal fuel supply, can be indicated to the outside through the annunciator 22. The user can therefore exactly judge the conditions of the DMFC unit 2 and use the fuel cell system at all times under the best conditions.

The first and second threshold voltages E1 and E2 with which the electromotive force of each of the power generating cells 2a to 2c is compared, and the operating time of the monostable multivibrator 18 to set the set time τ1 are corrected according to the temperature of the vicinity of the DMFC unit 2 which is detected by the temperature sensor 10. Therefore, even if the electromotive forces of the power generating cells 2a to 2c vary according to the ambient temperature, the conditions of the DMFC unit 2 can be detected exactly and indicated to the outside.

(Modification)

In the embodiment described above, the control means has been described in terms of hardware including logic circuitry; however, the control means can be implemented in software.

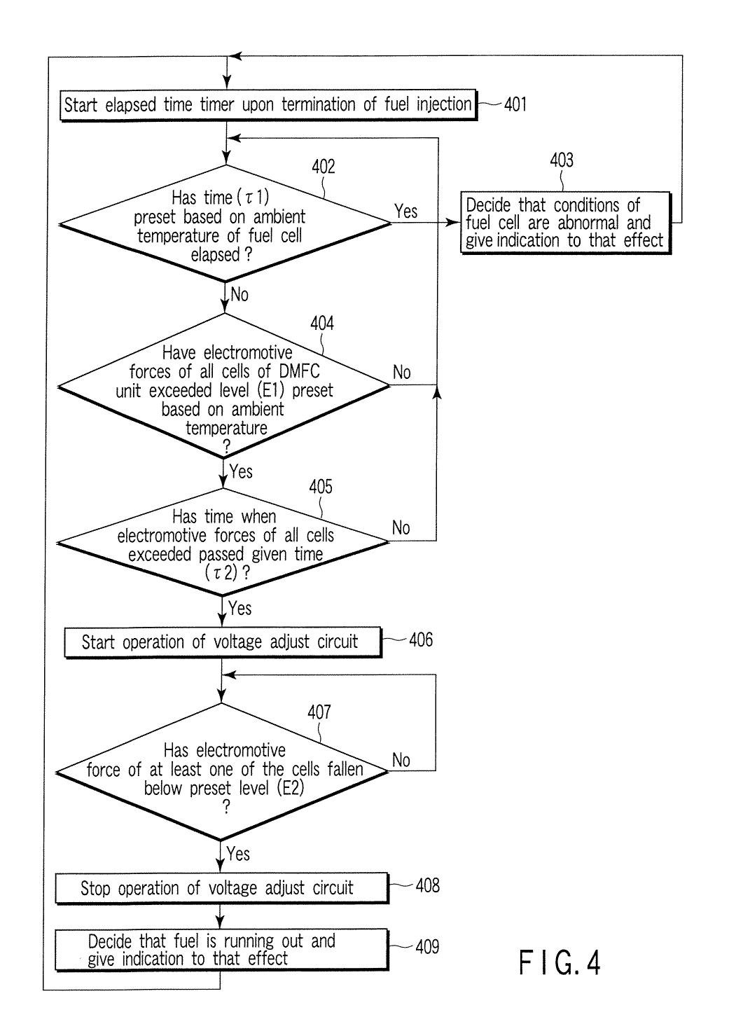

In this modification, as the control means use is made of software including a program that allows a computer to perform such an operation as shown in FIG. 4. First, in step 401, an elapsed time timer is started when the fuel injection is terminated. The procedure then goes to step 402 in which a decision is made based on the elapsed time timer as to whether or not a time (corresponding to the set time τ1 described above) determined based on the ambient temperature of the fuel cell (DMFC unit 2) has elapsed from the time at which the fuel injection was terminated. Here, the procedure goes to step 403 if the time has elapsed and step 404 otherwise. In step 403, it is decided that the conditions of the fuel cell, that is, the fuel supply to some of the power generating cells 2a to 2c in the DMFC unit 2, are abnormal (corresponding to the generation of the H-level abnormal fuel supply signal described above) and the user is notified to that effect via the annunciator 22. The procedure then returns to step 401. In step 404, a decision is made as to whether or not the electromotive force of each of the cells (power generating cells 2a to 2c) in the DMFC unit 2 has exceeded a level (corresponding to the first threshold voltage E1) determined based on the ambient temperature. The procedure goes to step 405 if the decision is YES and step 402 otherwise. In step 405, a decision is made as to whether the time at which the electromotive forces of all the cells exceeded that level has passed a given time (corresponding to the set time τ2). If the decision is YES (corresponding to the generation of the H-level feed enable signal D), the procedure goes to step 406 and, if not, to step 402. In step 406, the voltage adjust circuit 9 is operated to adjust the output voltage of the DMFC unit 2 and apply it to the portable electronic equipment 8. The procedure then goes to step 407. In this case, the annunciator 22 is caused to make notification to the effect that the supply of power is normal. In step 407, a decision is made as to whether or not the electromotive force of at least one of the cells is below a preset level (corresponding to the second threshold voltage E2). If the decision is YES, the procedure goes to step S408; otherwise, step 407 is repeated. In step 408, the operation of the voltage adjust circuit 9 is stopped and the procedure then goes to step 409 in which it is decided that the fuel is exhausted and the user is notified to that effect via the annunciator 22.

This modification can provide the same advantages as the embodiment described above.

The present invention is not limited to the embodiments described above and, at the stage of practice, can be embodied in various forms without departing from the scope thereof. The constituent elements disclosed in the above embodiments can be combined appropriately to form various inventions. For example, some of the constituent elements shown in the embodiments may be removed. Furthermore, the constituent elements described in the different embodiments may be combined appropriately.

For example, the annunciator 22 can use a device, such as a vibrator, that generates vibration. The use of such a vibrator allows the user to be notified with certainty through vibration even in a case where the user uses (takes along) the portable electronic equipment 8 in a pocket or the like. Furthermore, such an annunciator can be set in the control unit 3 on the side of the DMFC unit 2 instead of in the portable electronic equipment 8 to provide the same advantages as when it is set in the portable electronic equipment.

In addition, it goes without saying that the present invention can be practiced in various modified forms without departing from the scope thereof.

The present invention provides a fuel cell system which can exactly indicate the conditions of a DMFC unit to the outside.

What is claimed is:

1. A fuel cell system comprising:
a fuel cell unit including a plurality of power generating cells;
threshold setting means for setting a first threshold and a second threshold for each of the power generating cells;
comparison means for comparing the electromotive force of each of the power generating cells with either of the first threshold or the second threshold;
first time setting means for setting a first standby time with termination of fuel injection into the fuel cell unit as starting point of time;
decision means for making a decision of, (a) when the comparison means makes comparisons using the first threshold, whether or not the electromotive forces of all the power generating cells exceed the first threshold within the first standby time and, (b) when the comparison means makes comparisons using the second threshold, whether or not the electromotive force of at least one of the power generating cells falls below the second threshold;
control means for controlling a supply of power to a load by the fuel cell unit based on results of decision by the decision means; and
annunciation means for indicating the results of decision by the decision means.

2. The system according to claim 1, wherein the first threshold is determined on the basis of the electromotive forces of the power generating cells immediately after fuel injection into the fuel cell unit.

3. The system according to claim 1, wherein the second threshold is determined on the basis of the electromotive forces of the power generating cells when the fuel cell unit is running out of fuel.

4. The system according to claim 1, wherein the first standby time is determined based on time which elapses from the termination of fuel injection into the fuel cell unit to time when the fuel has been distributed to each of the power generating cells.

5. The system according to claim 1, wherein the annunciation means indicates that the supply of power is normal (c) when the decision means decides that the electromotive forces of all the power generating cells exceed the first threshold within the first standby time, that the supply of power is abnormal (d) when the decision means decides that the electromotive force of at least one of the power generating cells fall below the first threshold within the first standby time, and that the fuel is running out (e) when the decision means decides that the electromotive force of at least one of the power generating cells falls below the second threshold.

6. The system according to claim 1, wherein the control means starts the supply of power to the load by the fuel cell unit (f) when the decision means decides that the electromotive forces of all the power generating cells exceed the first threshold within the first standby time, and stops the supply of power to the load by the fuel cell unit (g) when the decision means decides that the electromotive force of at least one of the power generating cells falls below the second threshold.

7. The system according to claim 1, further comprising temperature detecting means for detecting an ambient temperature of the fuel cell unit, and wherein the threshold setting means corrects the first threshold and the second threshold based on results of detection by the temperature detecting means.

8. The system according to claim 7, wherein the first time setting means corrects the first standby time based on the results of detection by the temperature detecting means.

9. The system according to claim 6, further comprising second time setting means for setting a second standby time shorter than the first standby time, and wherein the control means starts the supply of power to the load by the fuel cell unit after the second standby time has elapsed.
